(19) United States
(12) Patent Application Publication
(10) Pub. No.: US 2016/0064906 A1
(43) Pub. Date: Mar. 3, 2016

(54) WIRE HARNESS ELECTRICAL LINE EXTERIOR STRUCTURE

(71) Applicant: SUMITOMO WIRING SYSTEMS, LTD., Mie (JP)

(72) Inventors: Masataka WAKABAYASHI, Mie (JP); Haruki KONAGAYOSHI, Mie (JP)

(73) Assignee: SUMITOMO WIRING SYSTEMS, LTD., Mie (JP)

(21) Appl. No.: 14/824,543

(22) Filed: Aug. 12, 2015

(30) Foreign Application Priority Data
Sep. 2, 2014 (JP) 2014-178330

(51) Int. Cl. H02G 3/04; B60R 16/02

(52) U.S. Cl. CPC H02G 3/0406; B60R 16/0215

(57) ABSTRACT

A wire harness electrical line exterior structure has favorable workability in a wire harness mounting task, prevents unnecessary constricting force from being applied to an electrical line group by an exterior member after mounting, and allows an improvement in the bendability and the durability of the electrical line group. The wire harness electrical line exterior structure includes an electrical line group including electrical lines, and an exterior member enclosing the electrical line group. The exterior member includes a shape memory material attached to the electrical line group in a first exterior orientation adjacent thereto. The shape memory material is molded so as to be capable of returning to a predetermined remembered shape. When the shape memory material is heated so as to return to the remembered shape, the exterior member increases in width from the first exterior orientation to a second exterior orientation separated from the electrical line group.

### TECHNICAL FIELD

The present invention relates to a wire harness electrical line exterior structure, and in particular relates to a wire harness electrical line exterior structure in which an electrical line group is covered by an exterior member in a predetermined routing section.

### BACKGROUND ART

Conventionally, wire harnesses mounted in vehicles and the like have often used an electrical line exterior structure in which an electrical line group is protected by an exterior member in a predetermined routing section in which bending, sliding, and the like of the electrical line group occurs.

Also, known examples of the exterior member include vinyl tape, a vinyl tube, and a corrugated tube, and it is known that by using a spiral tube made of resin, it is possible to constitute an exterior member that prevents damage and breakage at low temperatures without impairing the bendability of the wire harness (e.g., see JP 2001-239900A).

JP 2001-239900A is an example of related art.

### SUMMARY OF THE INVENTION

However, with the above-described conventional wire harness electrical line exterior structure, a spiral tube made of relatively hard resin is attached to the electrical line group of the wire harness so as to constrict the electrical line group, and therefore in the case where relatively strong constricting force is applied to the electrical line group in order to stabilize the bound state of the electrical line group, the bendability of the electrical line group decreases, unnecessary internal stress is generated in the electrical line group, and there has been concern of this leading to a decrease in the durability of the wire harness.

Also, the relatively thick spiral tube made of hard resin is roughly wrapped around the electrical line group, and therefore if the spiral tube is guided by or interferes with a vehicle part, there is a possibility of impaired workability in the task of mounting the electrical line group to the vehicle or the like, or a possibility of the electrical line group bending movement or the like being hindered by the spiral tube.

The present invention was achieved in order to solve the aforementioned conventional problems, and an object thereof is provide a wire harness electrical line exterior structure that has favorable workability in the wire harness mounting task, prevents unnecessary constricting force from being applied to the electrical line group by the exterior member after mounting, and allows an improvement in the bendability and the durability of the electrical line group.

In order to achieve the above object, a wire harness electrical line exterior structure according to the present invention is a wire harness electrical line exterior structure including: an electrical line group constituted by a plurality of electrical lines; and an exterior member that encloses the electrical line group, wherein the exterior member is constituted by a shape memory material being attached to the electrical line group in a first exterior orientation of being adjacent to the electrical line group, the shape memory material being molded so as to be capable of returning to a predetermined remembered shape, and when the shape memory material is heated so as to return to the remembered shape, the exterior member increases in width from the first exterior orientation to a second exterior orientation of being separated from the electrical line group.

According to this configuration, with the present invention, in the state before mounting of the wire harness in which the exterior member is in the first exterior orientation, the outer diameter of the exterior member is suppressed to a small diameter, and the electrical line group of the wire harness is held in the state of being constricted in a bundled manner, and thus the wire harness does not bulge, and handling is easy. Also, when the shape memory material is heated to a predetermined temperature or higher in the stage in which the wire harness is mounted along a predetermined routing path (including the period during mounting and a predetermined period immediately thereafter), the shape memory material returns to the remembered shape, and the exterior member increases in width to the second exterior orientation. Accordingly, this wire harness electrical line exterior structure has favorable workability in the wire harness mounting task, prevents unnecessary constricting force from being applied to the electrical line group by the exterior member after mounting, and allows an improvement in the bendability and the durability of the electrical line group.

In the wire harness electrical line exterior structure of the present invention, it is desirable that the shape memory material is constituted as a band-shaped body having a band shape overall, is wrapped around the electrical line group in the first exterior orientation, and transitions to the second exterior orientation while expanding in a length direction of the band-shaped body when returning to the remembered shape.

According to this configuration, the shape memory material can be produced easily, and the task of attachment to the electrical line group is also facilitated.

In the wire harness electrical line exterior structure of the present invention, the shape memory material may be wrapped in a spiral manner around the electrical line group in a half-wrap state in which sides in a band width direction of the band-shaped body overlap each other in a radial direction of the electrical line group, and after being wrapped in the half-wrap state, an end portion on an innermost layer side of the shape memory material and an end portion on an outermost layer side of the shape memory material may be fixed to the electrical line group.

According to this configuration, the axial length of the exterior member can be set to any length in accordance with the wrapping length of the shape memory material around the electrical line group, and it is possible to improve the protective function of the exterior member by forming the exterior member in the shape of a tube having substantially no gaps in the axial direction between the fixing positions where the two end portions of the shape memory material are fixed to the electrical line group.

In the wire harness electrical line exterior structure of the present invention, in the first exterior orientation, the shape memory material may be shrunk in the length direction while being bent a plurality of times in a thickness direction so as to have a maximum thickness and a minimum length of the band-shaped body, and when returning to the remembered shape, the shape memory material may expand in the length direction while becoming flattened in the thickness direction so as to have a minimum thickness and a maximum length of the band-shaped body.

According to this configuration, it is possible to sufficiently increase the expansion in width of the exterior member from the first exterior orientation to the second exterior orientation.

According to the present invention, it is possible to provide a wire harness electrical line exterior structure that has favorable workability in the wire harness mounting task, prevents unnecessary constricting force from being applied to the electrical line group by the exterior member after mounting, and allows an improvement in the bendability and the durability of the electrical line group.

### BRIEF DESCRIPTION OF THE DRAWINGS

FIG. 1 is a process illustration diagram showing a side view of relevant portions in diameter enlargement change from a first exterior orientation to a second exterior orientation of an exterior member in a wire harness electrical line exterior structure according to an embodiment of the present invention;

FIG. 2 is a process illustration diagram showing a transverse cross-sectional view of relevant portions in diameter enlargement change from the first exterior orientation to the second exterior orientation of the exterior member in the wire harness electrical line exterior structure according to the embodiment of the present invention;

FIG. 3 is a process illustration diagram showing a plan view of a shape memory material used as the exterior member of the wire harness shown in FIGS. 1 and 2, in a stage in which the shape memory material undergoes fabricating from a molded shape into a shrunk shape, and in a stage in which the shape memory material expands again from the shrunk shape so as to return to the remembered shape;

FIG. 4 is a process illustration diagram showing a side view of the shape memory material used as the exterior member of the wire harness shown in FIGS. 1 and 2, in the stage in which the shape memory material undergoes fabricating from a molded shape into a shrunk shape, and in the stage in which the shape memory material expands again from the shrunk shape so as to return to the remembered shape; and

FIG. 5 is an illustrative diagram of exterior member attachment steps in a wire harness electrical line exterior structure according to a comparative example.

### EMBODIMENTS OF THE INVENTION

Hereinafter, an embodiment for carrying out the present invention will be described with reference to the drawings.

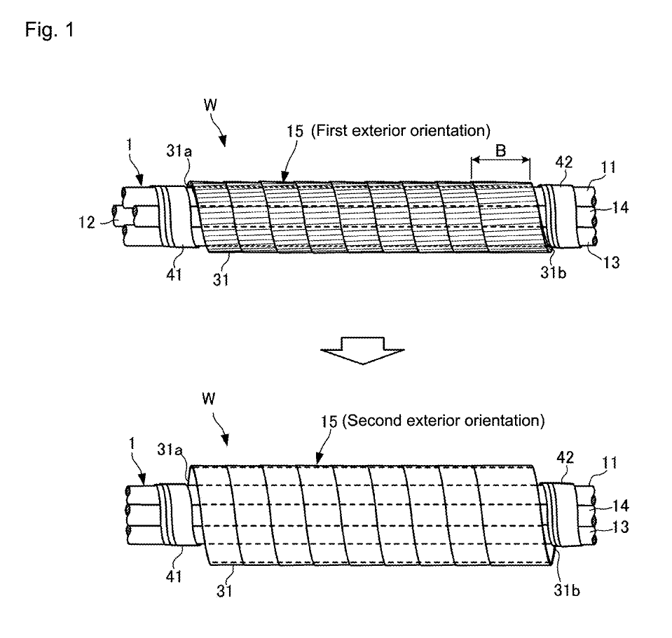

FIGS. 1 to 4 show an electrical line group 1 of a wire harness W having a wire harness electrical line exterior structure according to an embodiment of the present invention.

Note that the wire harness W of the present embodiment is a unit in which multiple connection terminals, connectors, and the like (not shown) are attached to the bundled electrical line group 1, and is configured such that, for example, electronic devices equipped in a vehicle can be connected to a power source, control equipment, or the like.

The electrical line group 1 of the wire harness W has flexibility that enables routing along a predetermined routing path on a vehicle body panel (not shown), and allows a change in the position and curved shape of a portion (hereinafter, referred to as the curved route portion) spanning between the vehicle body panel and a movable portion such as a door or seat provided in the vehicle.

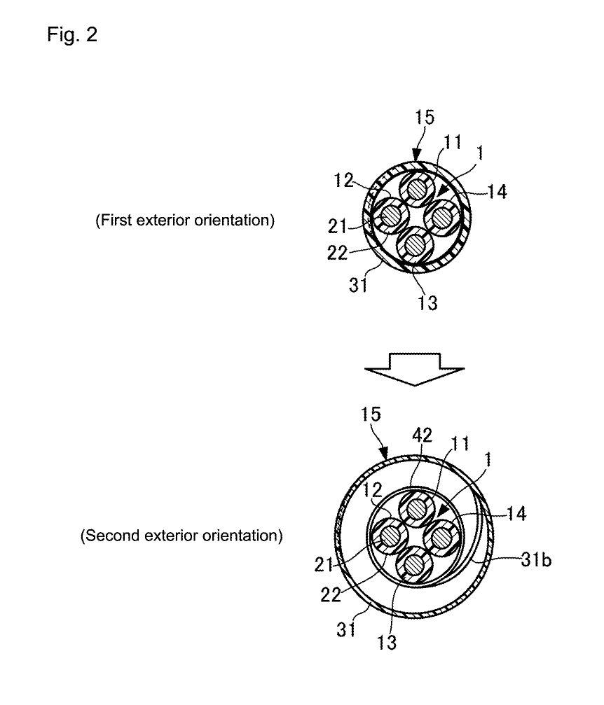

As shown in FIGS. 1 and 2, the electrical line group 1 (a plurality of electrical lines) includes electrical lines 11, 12, 13, and 14, an approximately cylindrical exterior member 15 that encloses the electrical lines 11 to 14 in the curved route portion of the wire harness W so as to hold them in a bundled manner, and exterior member fixing portions 41 and 42 that bundle together the electrical lines 11 to 14 in the vicinity of the curved route portion and fix the two end portions of the exterior member 15 to the bundle of electrical lines 11 to 14.

The electrical lines 11 to 14 each have a linear conductor 21 and a tubular sheathing 22 that encloses the conductor 21, and the conductor 21 is constituted by a circular stranded line obtained by twisting together multiple element wires, which are annealed copper wires (annealed conductor wires), for example. Of course, the conductor 21 may be constituted as a single-line core line instead of a stranded line. The sheathing 22 is constituted by a cylindrical insulating member made of resin whose main component is vinyl chloride, polyethylene, or the like.

In the wire harness W before mounting to the vehicle body (before routing), the exterior member 15 is attached to the electrical line group 1 in the curved route portion in a first exterior orientation of being adjacent to the electrical line group 1 as shown on the upper side in FIG. 2.

Specifically, the exterior member 15 is constituted to include a flexible shape memory material 31 that can return to a remembered shape when heated to a temperature greater than or equal to a predetermined temperature (e.g., a temperature determined according to the material, within the range of 60 degrees to 80 degrees Celsius) that exceeds the ordinary temperature range (e.g., the range of 5 degrees to 35 degrees Celsius). The shape memory material 31 is formed as a band-shaped body having a band shape with a constant width, and is formed from a polyurethane-based shape memory resin, which is a high-performance material that can exhibit a shape memory effect, for example.

The shape memory material 31 is wrapped in a spiral manner around the electrical lines 11 to 14 of the electrical line group 1, and thus the exterior member 15 is overall in an approximately cylindrical small-diameter first exterior orientation of being adjacent to the electrical line group 1 before the wire harness W is routed (mounted) on the vehicle body panel, as shown in the upper portion in FIGS. 1 and 2.

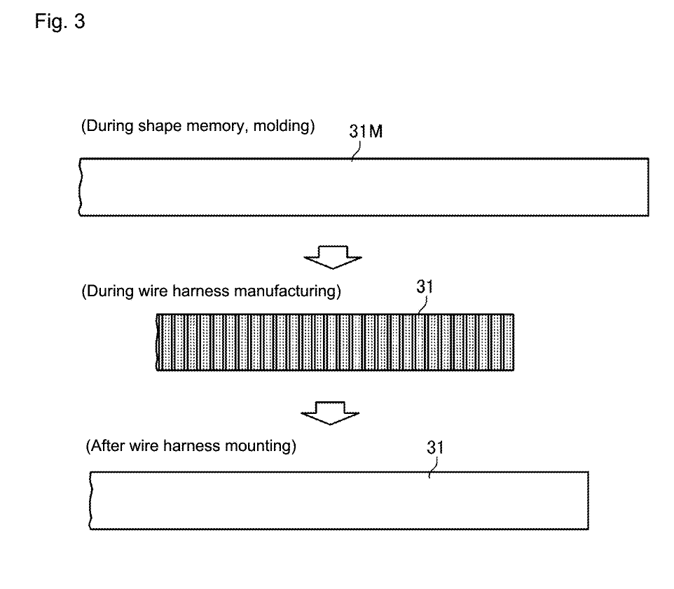

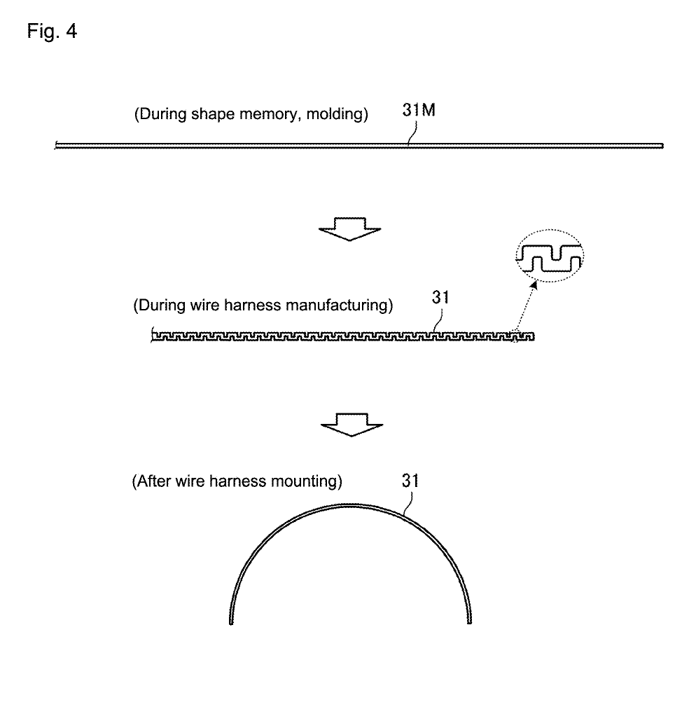

More specifically, the shape memory material 31 includes an initial shape material 31M molded into a band plate shape (may be curved in the wrapping direction) having a constant width as shown in the upper portion of FIGS. 3 and 4. As shown in the middle portion of these figures, the initial shape material 31M is deformed into a predetermined bent shape of winding in a zigzag manner in the thickness direction at a predetermined fabricating temperature that is lower than the molding temperature, and this winding shape is caused to remain.

The predetermined fabricating temperature referred to here is, for example, a temperature in the ordinary temperature range or a temperature somewhat higher than the ordinary temperature range while being sufficiently lower than the molding temperature of the shape memory material 31, and in the latter case, the initial shape material 31M may be deformed into the predetermined bent shape of winding in a zigzag manner in the thickness direction at the fabricating temperature as shown in the middle portion of FIGS. 3 and 4, and then cooled to room temperature while being kept in the deformed state. Although the temperatures depend on the material for forming the shape memory material 31, the molding temperature is a temperature that exceeds the glass transition point (phase transition temperature) of the material, such as a temperature of approximately 200 degrees Celsius, and the predetermined fabricating temperature is a temperature below the glass transition point, such as a temperature set depending on the material selection in the range of 40 to 120 degrees Celsius. Note that the shape memory polymer itself that forms the initial shape material 31M is widely known.

The shape memory material 31 can maintain the predetermined bent shape shown in the middle portion of FIGS. 3 and 4 in the ordinary temperature range, and then when heated to a predetermined heating temperature higher than either the predetermined fabricating temperature or the glass transition point, shape restoration force for returning to the remembered shape, which is the molded shape (the initial shape or the shape upon cooling after deformation at or above the glass transition point), is generated.

In the exterior member 15 that is in the first exterior orientation, the shape memory material 31 is wrapped in a spiral manner around the electrical line group 1 in a half-wrap state in which sides in the band width direction (the direction of the band width B in FIG. 1) overlap each other in the radial direction of the electrical line group 1.

Then, with the wrapped shape memory material 31 in the half-wrap state, one end portion 31a thereof on the innermost layer side and another end portion 31b thereof on the outermost layer side are respectively fixed to the electrical line group 1 by the corresponding exterior member fixing portions 41 and 42.

As one example of the exterior member fixing portion 41, widely known vinyl tape having an adhesive surface on one surface is wrapped multiple times around the one end portion 31a of the shape memory material 31 and the electrical lines 11 to 14 of the electrical line group 1 (e.g., is wrapped in three overlapping layers), thus fixing the one end portion 31a of the shape memory material 31 to the electrical line group 1. Also, as the exterior member fixing portion 42, the aforementioned vinyl tape is wrapped multiple times around the other end portion 31b of the shape memory material 31 and the electrical lines 11 to 14 of the electrical line group 1 (e.g., wrapped in three overlapping layers), thus fixing the other end portion 31b of the shape memory material 31 to the electrical line group 1.

In this way, when the exterior member 15 is in the first exterior orientation with respect to the electrical line group 1 as shown in the upper portion of FIGS. 1 and 2, the shape memory material 31 is bent multiple times in the thickness direction so as to have the maximum thickness and the minimum length of the band-shaped body shape, and has the predetermined bent shape of being shrunk in the length direction (see the middle portion of FIGS. 3 and 4).

On the other hand, the wire harness W is shipped in the state in which the exterior member 15 is attached to the electrical line group 1 in the first exterior orientation, and is routed on a vehicle body panel in a vehicle assembly plant, for example.

In this routing stage, the exterior member 15 encloses the curved route portion that has a curved shape and in which the wire harness W spans between the vehicle body panel and a movable portion, and the exterior member 15 is heated to a predetermined heating temperature at which a return to the remembered shape is possible, from the other end portion 31b side (outermost layer side) of the shape memory material 31 in the routing stage or immediately thereafter.

When heated in this way, the exterior member 15 expands in the length direction while becoming flattened in the thickness direction such that the shape memory material 31 has the minimum thickness and the maximum length of the initial band-shaped body shape that is close to the remembered shape, thus transitioning to the second exterior orientation shown in the lower portion of FIGS. 1 and 2.

Note that the one end portion 31a and the other end portion 31b of the shape memory material 31 are fixed to the electrical line group 1 by the exterior member fixing portions 41 and 42 respectively, and when the exterior member 15 is in the second exterior orientation, the shape of the shape memory material 31 after returning toward the remembered shape is a shape in which the shape of being curved in the direction of wrapping around the electrical line group 1 remains as shown in the lower portion of FIGS. 3 and 4.

Accordingly, in the half-wrap portion of the spiral-shaped shape memory material 31 that increased in width to the second exterior orientation, the portions of the shape memory material 31 that overlap each other in the radial direction due to the remaining stress in the direction of complete return to the initial state are in a state of close contact with predetermined contact pressure, and the tubular shape of the exterior member 15 after width increase is held.

In the present embodiment, when the shape memory material 31 of the exterior member 15 is heated so as to return to the remembered shape in this way, the exterior member 15 increases in width from the first exterior orientation to the second exterior orientation of being separated from the electrical line group 1.

Also, when the exterior member 15 is in the first exterior orientation, the shape memory material 31 is shrunk in the length direction while being bent multiple times in the thickness direction so as to have the maximum thickness and the minimum length of the band-shaped body, and then when returning to the remembered shape, the exterior member 15 expands in the length direction while becoming flattened in the thickness direction so as to have the minimum thickness and the maximum length of the band-shaped body.

Next, effects will be described.

In the present embodiment configured as described above, in the state before mounting of the wire harness W in which the exterior member 15 is in the first exterior orientation, the outer diameter of the exterior member 15 is suppressed to a small diameter, and the electrical line group I of the wire harness W is held in the state of being constricted in a bundled manner.

Accordingly, the exterior member 15 does not bulge when the wire harness W is shipped and transported, and it is easy to handle the electrical line group 1 that is held in a bundled manner by the exterior member 15.

Next, during or immediately before mounting of the wire harness W to a vehicle body panel along a predetermined routing path, a dryer or the like is used to heat the shape memory material 31 that constitutes the exterior member 15 to a predetermined heating temperature or higher, and this heating is performed successively from the other end portion 31b side to the one end portion 31a side.

At this time, restoring force in the direction of returning to the remembered shape is successively generated in the shape memory material 31 that constitutes the exterior member 15, from the other end portion 31b side that is the outermost layer to the one end portion 31a side that is the innermost layer side, and the exterior member 15 increases in width from the first exterior orientation to the second exterior orientation of being separated from the electrical line group 1.

Accordingly, the wire harness W electrical line exterior structure has favorable workability in the wire harness W mounting task, prevents unnecessary constricting force from being applied to the electrical line group 1 by the exterior member 15 after mounting, and allows an improvement in the bendability and the durability of the electrical line group 1 by eliminating unnecessary internal stress caused by such unnecessary constriction.

Moreover, the exterior member 15 can increase in width to a diameter dimension that is sufficiently larger than at the time of shipment of the wire harness W, and that is optimum to the mounting aspect, and can increase in width into a tubular shape that follows a guide groove or a guide plane of the vehicle body, and it is possible to significantly improve the exterior member mounting task.

Also, in the present embodiment, the shape memory material 31 of the exterior member 15 is constituted as a band-shaped body, is wrapped around the electrical line group 1 in the first exterior orientation, and then transitions to the second exterior orientation as it expands in the length direction of the band-shaped body when returning to the remembered shape. Accordingly, it is possible to easily manufacture the shape memory material 31, and the task of attaching the exterior member 15 to the electrical line group 1 is easy.

Furthermore, with the wire harness W of the present embodiment, the one end portion 31a on the innermost layer side and the other end portion 31b on the outermost layer side of the shape memory material 31, which is wrapped in a spiral manner around the electrical line group 1 in the half-wrap state, are fixed to the electrical line group 1. Accordingly, the axial length of the exterior member 15 can be set to any length in accordance with the wrapping length of the shape memory material 31 around the electrical line group 1, and it is possible to improve the protective function of the exterior member 15 by forming the exterior member 15 in the shape of a tube having substantially no gaps in the axial direction between the fixing positions where the two end portions of the shape memory material 31 are fixed to the electrical line group 1.

Additionally, in the present embodiment, when the exterior member 15 is in the first exterior orientation, the shape memory material 31 shrinks in the length direction while being bent multiple times in the thickness direction so as to have the maximum thickness and the minimum length, and when returning to the remembered shape, the shape memory material 31 expands in the length direction while becoming flattened in the thickness direction so as to have the minimum thickness and the maximum length. Accordingly, it is possible to sufficiently increase the expansion in width of the exterior member 15 from the first exterior orientation to the second exterior orientation. As a result, the exterior member 15 is not likely to hinder a change in the bending orientation of the electrical lines 11 to 14 of the electrical line group 1 that accompanies the movement of a movable portion of the vehicle body, and it is possible to improve the bendability and the durability of the electrical line group 1.

In this way, in the present embodiment, it is possible to provide a wire harness electrical line exterior structure that has favorable workability in the wire harness W mounting task, prevents unnecessary constricting force from being applied to the electrical line group 1 by the exterior member 15 after mounting, and allows an improvement in the bendability and the durability of the electrical line group 1.

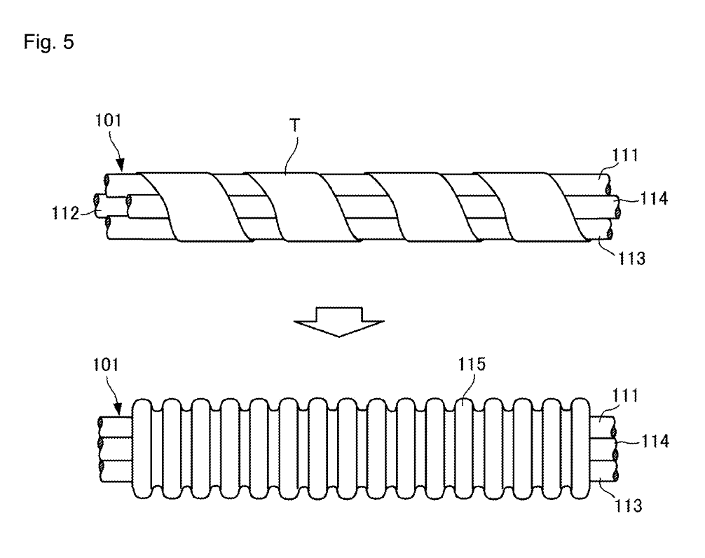

FIG. 5 shows a wire harness exterior structure according to a comparative example in order to clarify the above-described actions and effects of the present invention.

As shown in the upper portion of FIG. 5, in this comparative example, vinyl tape T is roughly wrapped in advance in a spiral manner around the curved route portion of electrical lines 111 to 114 that constitute an electrical line group 101 so as to temporarily bundle together the electrical lines 111 to 114, and then the temporarily bundled electrical line group 101 is inserted into a flexible corrugated tube 115 such that the curved route portion of the electrical line group 101 is covered by the corrugated tube 115.

In this case, the diameter dimension of the corrugated tube 115 does not change, and therefore a corrugated tube 115 having an inner diameter that is large to a certain extent is necessary due to the need to ensure a range of mobility for the electrical line group 101 and a bending orientation that is favorable to a certain extent after mounting. For this reason, the wire harness that is covered by the corrugated tube 115 before mounting bulges in the diameter direction.

Moreover, due to the need to ensure a range of mobility for the electrical line group 101 in the corrugated tube 115 and facilitate the mounting of the corrugated tube 115, it is necessary to temporarily bundle the curved route portion of the electrical line group 101 by roughly wrapping it with the vinyl tape T in a relatively tight manner.

For this reason, the vinyl tape T applies unnecessarily strong constricting force to the electrical line group 101 covered by the corrugated tube 115, and the internal stress in the electrical lines caused by this constriction reduces the bendability of the electrical line group 101 and leads to friction and the like between the sheathings of the electrical lines 111 to 114, and thus there is the concern of a decrease in the durability of the electrical line group 101. Also, long and thin gaps are formed between the electrical lines 111 to 114, and therefore water easily penetrates the regions between electrical lines when covered by water, and there is a concern of this leading to secondary wetting.

In contrast, it is understood that with the above-described embodiment all of the above-described problems in the comparative example are resolved.

Note that the shape memory material 31 is shaped so as to have the maximum thickness and the minimum length while winding in a zigzag manner in the thickness direction of the band shape before mounting of the wire harness W in the above embodiment, but the shape memory material 31 may be wrapped in a spiral manner into a tubular shape and then flattened into a band shape, or zigzag folded lines may be inclined relative to the length direction of the band, for example.

Also, the shape memory material 31 is made of a shape memory resin in the above embodiment, but it may be made of an insulating shape memory alloy covered by rubber or a flexible resin.

Furthermore, the exterior member 15 is constituted by the shape memory material 31 that is wrapped in a spiral manner around the electrical line group 1, and the one end portion 31a and the other end portion 31b thereof are fixed to the electrical line group 1, but it is conceivable to form a tubular exterior member 15 in which the end portions 31a and 31b of the shape memory material 31 are fixed to an intermediate portion (another portion) instead of being fixed to the electrical line group 1, and the end portion positions are restricted by a guide member or a positioning member of the vehicle body.

It goes without saying that it is not necessarily required to half-wrap the shape memory material 31 in order to form the exterior member 15. Also, of course there are no particular limitations on the number of electrical lines in the electrical line group 1, the types of electrical lines, or the like.

As described above, the present invention enables providing a wire harness electrical line exterior structure that has favorable workability in the wire harness mounting task, prevents unnecessary constricting force from being applied to the electrical line group by the exterior member after mounting, and allows an improvement in the bendability and the durability of the electrical line group. The present invention is useful to general wire harness electrical line exterior structures in which an electrical line group is covered by an exterior member in a predetermined routing section.

LIST OF REFERENCE NUMERALS

| | |
|---|---|
| 1 | Electrical line group (electrical lines) |
| 11, 12, 13, 14 | Electrical lines |
| 15 | Exterior member |
| 21 | Conductor |
| 22 | Sheathing |
| 31 | Shape memory material |
| 31M | Initial shape material |
| 31a | One end portion (end portion on innermost layer side) |
| 31b | Other end portion (end portion on outermost layer side) |
| 41, 42 | Exterior member fixing portion |
| W | Wire harness |

What is claimed is:

1. A wire harness electrical line exterior structure comprising:
an electrical line group comprising a plurality of electrical lines; and
an exterior member enclosing the electrical line group,
wherein the exterior member comprises a shape memory material attached to the electrical line group in a first exterior orientation adjacent to the electrical line group, the shape memory material being molded so as to be capable of returning to a predetermined remembered shape, and
when the shape memory material is heated so as to return to the remembered shape, the exterior member increases in width from the first exterior orientation to a second exterior orientation separated from the electrical line group.

2. The wire harness electrical line exterior structure according to claim 1, wherein the shape memory material comprises a band-shaped body having a band shape overall, is wrapped around the electrical line group in the first exterior orientation, and transitions to the second exterior orientation while expanding in a length direction of the band-shaped body when returning to the remembered shape.

3. The wire harness electrical line exterior structure according to claim 2,
wherein the shape memory material is wrapped in a spiral manner around the electrical line group in a half-wrap condition in which sides in a band width direction of the band-shaped body overlap each other in a radial direction of the electrical line group, and
after being wrapped in the half-wrap condition, an end portion on an innermost layer side of the shape memory material and an end portion on an outermost layer side of the shape memory material are fixed to the electrical line group.

4. The wire harness electrical line exterior structure according to claim 3, wherein in the first exterior orientation, the shape memory material is shrunk in the length direction while being bent a plurality of times in a thickness direction so as to have a maximum thickness and a minimum length of the band-shaped body, and when returning to the remembered shape, the shape memory material expands in the length direction while becoming flattened in the thickness direction so as to have a minimum thickness and a maximum length of the band-shaped body.
